(19) United States
(12) Patent Application Publication
(10) Pub. No.: US 2009/0146487 A1
(43) Pub. Date: Jun. 11, 2009

(54) Motor Vehicle Seat with a Seat Back and a Belt Deflector

(76) Inventors: Burckhard Becker, Solingen (DE); Frank Peters, Nettetal (DE); Michael Hennicke, Solingen (DE)

Correspondence Address: MCCARTER & ENGLISH, LLP HARTFORD;CITYPLACE I, 185 ASYLUM STREET, HARTFORD, CT, 06103, US

(21) Appl. No.: 12/331,723

(22) Filed: Dec. 10, 2008

(30) Foreign Application Priority Data
Dec. 10, 2007 (DE) 10 2007 059642.3

(51) Int. Cl. B60R 22/00

(52) U.S. Cl. 297/483

(57) ABSTRACT

The seat back of a motor vehicle seat has a shoulder belt and a belt deflector. The belt deflector is associated with the seat back, is disposed in the region of an upper edge of the seat back and forms a deflection edge in which the shoulder belt is deflected by an angle of deflection. The deflection edge is partly formed by at least one sheave and the deflection edge is curved.

### CROSS-REFERENCE TO RELATED APPLICATIONS

This application claims priority to German Application No. DE 10 2007 059 642.3, filed Dec. 10, 2007, which is hereby incorporated by reference in its entirety as part of the present disclosure.

### BACKGROUND OF THE INVENTION

The invention relates to a motor vehicle seat with a seat back and a belt deflector that is associated with the seat back and that is disposed in the region of an upper edge of the seat back and forms a deflection edge in which a shoulder belt of a safety belt is deflected by an angle of deflection. It relates in particular to an integrated seat.

Such a motor vehicle seat has been known from DE 10 2006 060 179 A1. The safety belt is a three-point safety belt. From the patent application publication, it is known to dispose a retractor for the shoulder belt underneath the belt deflection; in the concrete case, it is retained on the seat frame. As a result, the shoulder belt, which enters the belt deflector at the usual angle on the front side of the seat back, extends downward, substantially parallel to the seat back on the rear side thereof. Generally, the shoulder belt is deflected more than 90°, with the angle of deflection typically ranging from 95 to 110°. By virtue of this high angle of deflection, considerable friction occurs on the deflection edge of the belt deflector. This friction must be overcome when a passenger, which has its seat belt fastened, moves forward with his upper body. It is desired here that the safety belt restricts as little as possible the freedom of movement as long as there is no crash.

An integrated seat comprising a shoulder belt exit in the upper seat back region is known from DE 10 2006 003 652 B3. Behind, there is a deflection member that is slidable within a guide. This deflection member is configured to be a sheave at which the shoulder belt is deflected about 105°.

Belt deflectors intended to be affixed to a B-pillar have been further known from DE 295 02 192 U1 and DE 2 738 115 A1. They have a sheave or friction-reducing balls contacting the shoulder belt.

In view of the integrated seat of the type mentioned herein above, it is the object of the invention to develop the belt deflector in such a manner that a passenger is less restricted by the belt deflector in his movements when he has his seat belt fastened and when there is no crash, meaning that he is more free to move the upper body forward, away from the seat back.

### SUMMARY OF THE INVENTION

In view of the motor vehicle seat of the type mentioned herein above, this object is achieved in that the deflection edge is partly formed by at least one sheave and that the deflection edge is curved. On this belt deflector of the motor vehicle seat, the deflection edge is formed in parts by a rigid ledge, in parts through as least one sheave. It is thus possible to realize a curved shape of the deflection edge. Through the at least one sheave, the friction of the belt with respect to the deflection edge is significantly reduced. This optimization of the belt force is particularly suitable for seats having the retractor in the seat back or underneath the seat part, since in these cases the angle of deflection is greater than 90°.

When the retractor is disposed underneath the seat part, as this is the case in the patent application publication mentioned herein above, it is advantageous also to provide a lower deflector for the shoulder belt, which is located in the lower part of the seat back or underneath, and to equip it with a sheave.

Other features and advantages of the invention will become more apparent upon reviewing the appended claims and the following non restrictive description of embodiments of the invention, given by way of example only with reference to the drawing.

### BRIEF DESCRIPTION OF THE DRAWINGS

FIG. 1: shows a perspective illustration of an integral seat in an oblique view from the top; the seat has a belt deflector and a retractor disposed underneath the seat part.

FIG. 2: shows an assembly drawing of a belt deflector in an upper part of a seat frame for a second exemplary embodiment, with the belt deflector being now provided on the other seat side.

FIG. 3: shows a carrier part as shown in FIG. 2, but now with three inserted sheaves.

FIG. 4: shows a sectional view taken along section line IV-IV in FIG. 2.

FIG. 5: shows a sectional view taken along section line V-V in FIG. 3.

FIG. 6: shows a carrier part with inserted sheaves for a third exemplary embodiment in a perspective illustration and similar to the view in FIG. 2.

FIG. 7: shows a rear side of the carrier part with inserted sheaves as shown in FIG. 6.

FIG. 8: is an illustration like FIG. 6, but viewed from a slightly different angle.

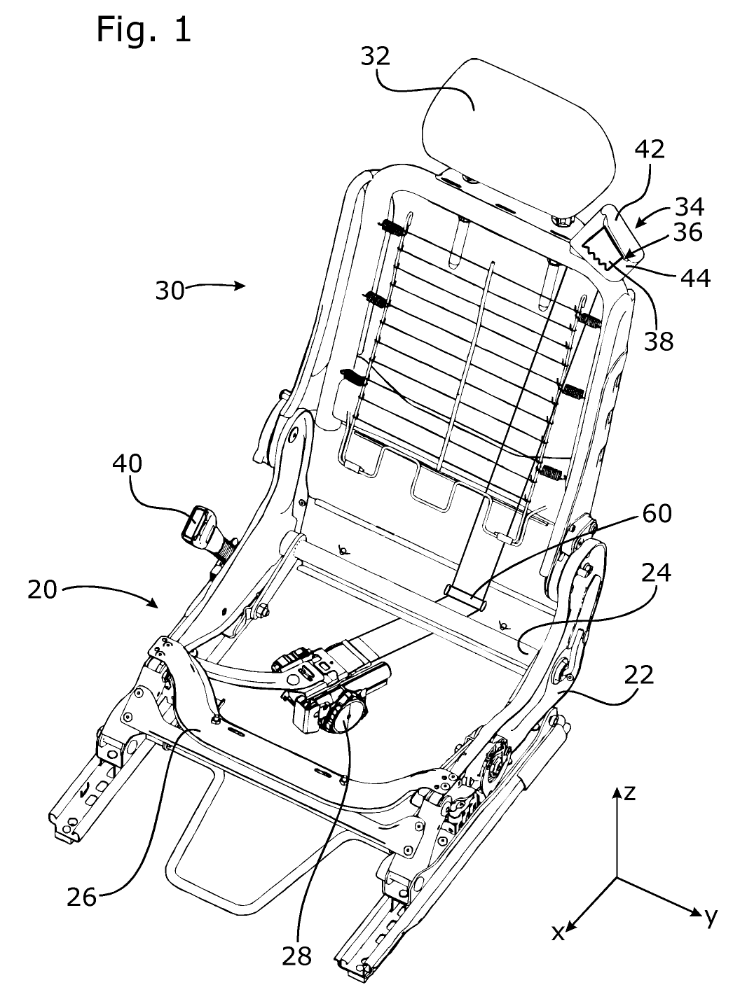

### DETAILED DESCRIPTION OF THE INVENTION

The motor vehicle seat has a seat part 20 that comprises i.a. two side parts 22, one rear tie bar 24 and one front tie bar 26. At this front tie bar 26 there is affixed a retractor 28 by means of a shackle; it is located approximately in the center underneath the seat part 20. The seat part 20 is supported toward the bottom in a known way by an underframe; two pairs of rails belong to the underframe.

The motor vehicle seat further has a seat back 30 that is connected to the two seat parts 22 through corresponding hinge mountings. In the region of a top edge of the seat back 30 and on the side next to a head rest 32, there is provided and affixed a belt deflector 34. It is disposed in proximity to the corner of a seat frame, is oriented slightly obliquely and is rigidly connected to the carrying frame of the seat back 30. It forms a deflection edge 36, which has a curved shape; it is also referred to as a J edge and defines toward the bottom an opening that is closed all over. Through this opening, a shoulder belt 38 of a three-point safety belt is threaded. A belt buckle 40 is provided on the other seat side, which lies opposite the belt deflector 34.

Details of the belt deflector will now be described and will become more apparent from the second and the third exemplary embodiment.

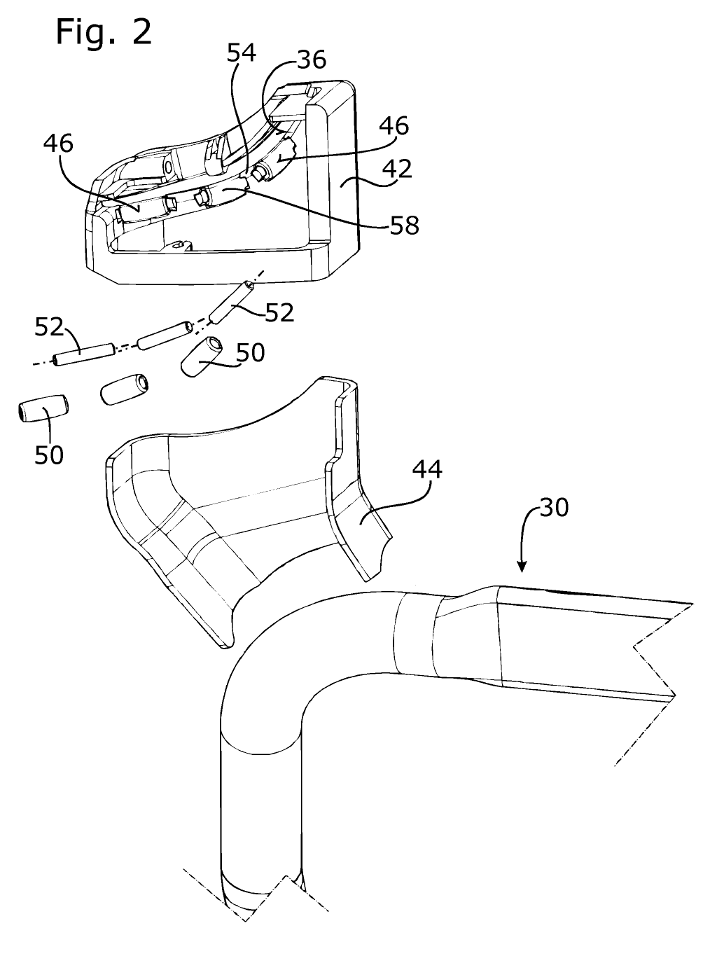

In the second exemplary embodiment shown in the FIGS. 2 through 5, the belt deflector 34 is located on the right next to a head rest 32 that has not been illustrated herein, thus being in a position like for example on a passenger seat of a left-hand drive motor vehicle. The belt deflector 34 has a carrier part 42 that forms the deflection edge 36. In the exemplary embodiment shown, it is configured to be a housing that also defines the opening described. In the mounted condition, it is received by a holding part 44 that is in turn solidly connected to the frame of the seat back 30.

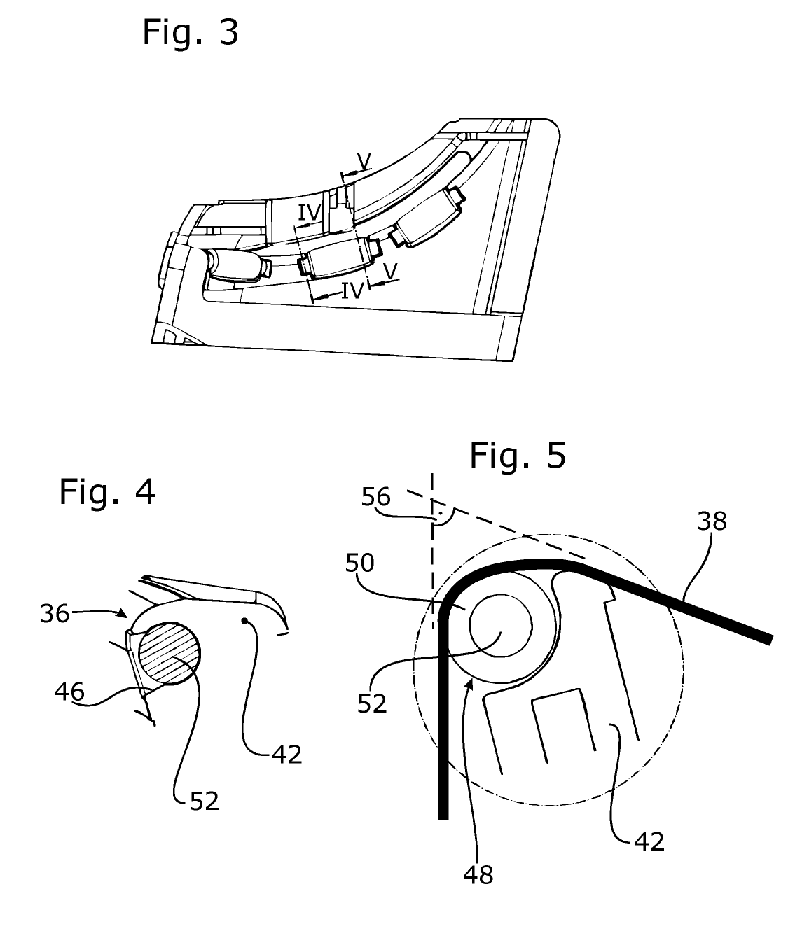

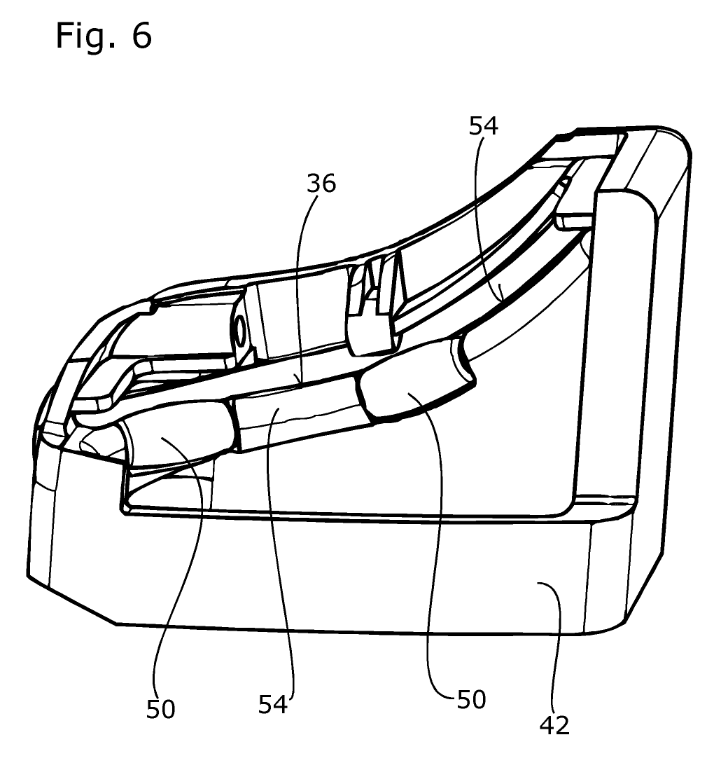

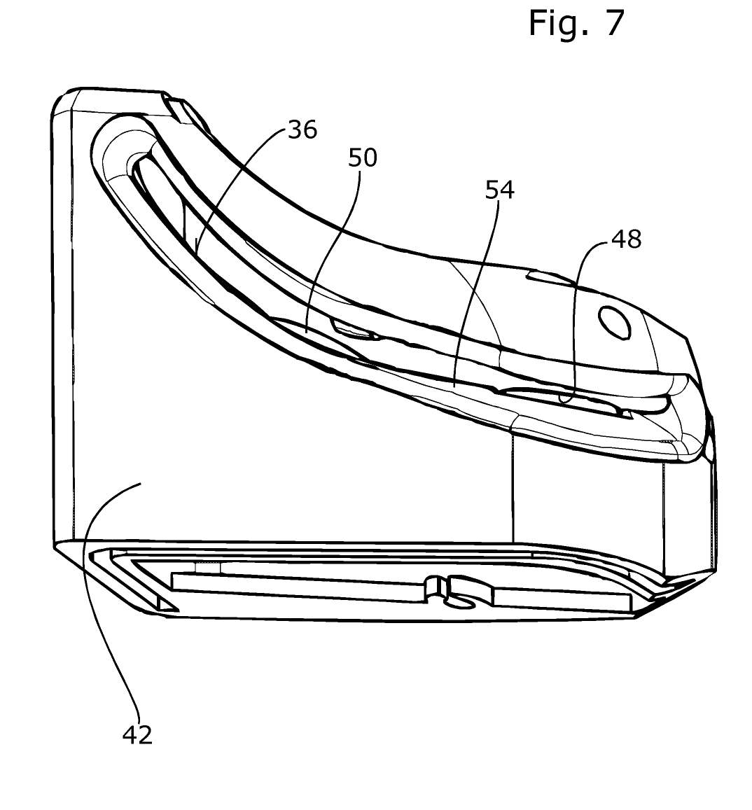

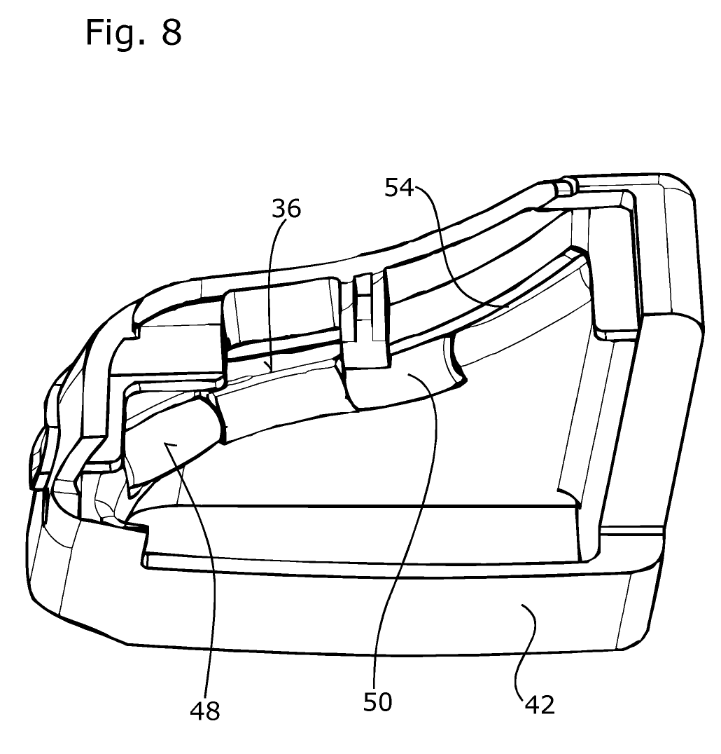

The carrier part 42 has three recesses 46 disposed one behind the other along the course of the deflection edge 36. In each recess 46 there can be releasably inserted, more specifically clipped, a sheave 48. Each sheave 48 has a sheave body 50 that is a rotating body and a sheave axle 52. In the exemplary embodiment shown, there are provided one-piece sheave axles 52 that can be plugged through centered, axial holes of the sheave body 50. It is also possible to have two short axle pins that can be plugged into blind holes of the sheave body 50. Preferably, a friction-reducing means, more specifically at least one ball bearing, is provided between the sheave body 50 and the sheave axle 52. The sheave axles 52 are longer than the sheave bodies 50; the excess length is at least 20%, preferably at least 30%. As a result, axle journals protrude from either side of the sheave body 50, as is evidenced in FIG. 3, which shows the assembled condition.

The sheave bodies 50 are configured to be spherical; in their axial center they have a diameter that is at least 10% greater than the diameter at their end regions. They may however also be configured in the reverse sense, so as to resemble a diabolo.

FIG. 2 shows that the illustrated three sheave axles 52, which are shown in the orientation of their mounting condition, have not the same axle. Their axes of rotation are inclined with respect to each other at an angle that is at least 3°, preferably at least 10°. They form, according to the shape of the deflection edge 36, not only an angle in the y-z plane, but also transverse thereto.

FIG. 2 shows that two rigid ledges 54 are located between the three recesses 46. There, no sheave 48 is provided and the deflection edge 36 is formed from a rigid part. This however is equipped so as to reduce friction as far as practicable, for example with a smooth surface. In FIG. 2, the deflection edge 36 extends, undisturbed. It is maintained in terms of construction by drawing the course of the two rigid ledges 54 beyond the recesses 46 until a border region on the side thereof and as a result in each end region of the deflection edge 36, where a short portion of rigid ledge 54 is provided or possibly not provided also. The undisturbed course of the deflection edge 36 corresponds to the course of the deflection edge 36 in a prior art deflection, the reader being referred to the printed documents mentioned herein above in this context.

When the sheaves 48 are mounted as shown in FIG. 3, the sheave bodies 50 project beyond the undisturbed course of the deflection edge 36 into the opening. Its outer contour is located at least some 10th of millimetres, preferably at least 1 mm, above the undisturbed deflection edge 36. In FIG. 3, the spherically configured sheave bodies 50 coincide at their axial end regions with the undisturbed course of the deflection edge 36 and their central region, which has a thicker diameter, protrudes from the undisturbed course of the deflection edge 36. One thus obtains a smooth course of the deflection edge 36. It is slightly undulated. As shown in FIG. 5, the sheaves 48 can be slightly offset, for example 1 to 5 mm, in the x direction with respect to the rigid ledge 54.

FIG. 4 shows how the sheave axles 52 are accommodated in side pockets forming the recesses 46. The sheave axles 52 can be clipped into these side pockets. Clipping occurs in a direction that also corresponds to the load exerted upon the safety belt, the sheaves 48 are more specifically clipped in a direction corresponding approximately to the bisector of the angle of deflection 56. The angle of deflection 56 is drawn in FIG. 5; it corresponds to the angle of intersection between the upward extended portion of a part of the shoulder belt 38 extending downward at the front and the upward extended portion of a rear part of this shoulder belt 38, as is shown in a dashed line in FIG. 5.

In any case, the deflection edge 36 is formed by at least one sheave 48 and at least one rigid ledge 54, at least two sheaves 48 and at least two rigid ledges 54 being preferred. They are disposed in a row, meaning one sheave 48 alternating with one ledge 54.

The recesses 46 have a bottom 58. In its normal condition, meaning when the shoulder belt 38 is not loaded, this bottom 58 is spaced a very small distance from the sheave body 50, as shown in FIG. 5. The distance is only a few 10th of millimetres, preferably less than 1 mm. When the shoulder belt 38 is loaded, the sheave axle 52 gives in and the sheave body 50 mechanically abuts the bottom 58. Thus, the sheaves 48 are subjected to quite little load. It is achieved that one sheave 48 detaches in the event of a crash. In the event of a crash, the amount of belt released by the sheave 48 giving in is thereby insignificant. It gives in the direction of a bisector of the angle of deflection 56.

Preferably, there is also provided a second deflection means 60. It is disposed approximately at the same height as the retractor 28 (related to the x-y plane). In the embodiment shown, it is located behind the tubular tie bar 24, which connects two rear rockers and in front of a rear transverse part that connects the two side parts 22. The deflection means 60 is configured to be a sheave 48 extending over the width of the shoulder belt and according to prior art, for example according to the mentioned document DE 27 38 115 A1. Preferably, it is carried on ball bearings. The deflection edge is now straight, it extends substantially parallel to the y direction.

What is claimed is:

1. A seat back of a motor vehicle seat comprising: a shoulder belt of a safety belt and a belt deflector, the belt deflector being associated with the seat back, the belt deflector being disposed in a region of an upper edge of the seat back and forming a deflection edge in which the shoulder belt is deflected by an angle of deflection, wherein the deflection edge is partly formed by at least one sheave and the deflection edge is curved.

2. The motor vehicle seat as set forth in claim 1, wherein at least two sheaves are provided, each of the at least two sheaves comprises a sheave axle, the sheave axles of the at least two sheaves extend at an angle greater than 5° with respect to each other.

3. The motor vehicle seat as set forth in claim 1, wherein a rigid ledge of the deflection edge is provided on at least one side of a sheave.

4. The motor vehicle seat as set forth in claim 1, wherein the deflection edge has an undisturbed course, and the at least one sheave protrudes at least 1 mm from the undisturbed course of the deflection edge.

5. The motor vehicle seat as set forth in claim 1, wherein a carrier part is provided and forms at least one portion of a rigid ledge, and the carrier part comprises at least one recess for insertion of a sheave.

6. The motor vehicle seat as set forth in claim 1, wherein a carrier part is provided, the carrier part comprises at least one recess for receiving a sheave.

7. The motor vehicle seat as set forth in claim 6, wherein the recess has a bottom, an air gap of less than 3 mm is present in a normal condition between the bottom of the recess and the sheave.

8. The motor vehicle seat as set forth in claim 1, wherein the sheave comprises a sheave body and a sheave axle, the sheave body has a length and a diameter, the length is one of (i) at least 3 times the diameter and (ii) at least 5 times the diameter.

9. The motor vehicle seat as set forth in claim 8, wherein the axle comprises axle journals that project in a longitudinal direction with respect to the sheave body, and holding devices are provided in a region of the recess for receiving a respective one of the axle journals.

10. The motor vehicle seat as set forth in claim 1, wherein the deflection edge is one of at least 1.5 times as long as the width of the shoulder belt and at least twice as long as the width of the shoulder belt.

11. The motor vehicle seat as set forth in claim 1, wherein an additional deflection means is provided.

12. The motor vehicle seat as set forth in claim 1, wherein the at least one sheave is one of (i) shorter in an axial direction than half the width of the shoulder belt and (ii) shorter in an axial direction than one third of the width of the shoulder belt.

13. The motor vehicle seat as set forth in claim 1, wherein at least two sheaves are provided, each of the two sheaves comprises a sheave axle, the sheave axles of the at least two sheaves extend at an angle greater than 10° with respect to each other.

14. The motor vehicle seat as set forth in claim 6, wherein the recess has a bottom, an air gap of less than 1 mm is free in a normal condition between the bottom of the recess and the sheave.
